(19) United States
(12) Patent Application Publication
(10) Pub. No.: US 2025/0091191 A1
(43) Pub. Date: Mar. 20, 2025

(54) POWER TOOL WITH MULTIPLE ACTUATOR CONFIGURATIONS

(71) Applicant: MILWAUKEE ELECTRIC TOOL CORPORATION, Brookfield, WI (US)

(72) Inventors: Robert Keys, Pewaukee, WI (US); Kyle Marten, Plymouth, WI (US); Brinn Blum, Brookfield, WI (US); Evan Brown, Milwaukee, WI (US); Ian Turner, Brookfield, WI (US); Nick Cera, Brookfield, WI (US); Jordan P. Gilsinger, Sussex, WI (US); Josh Navin, Brookfield, WI (US)

(21) Appl. No.: 18/886,557

(22) Filed: Sep. 16, 2024

Related U.S. Application Data
(60) Provisional application No. 63/639,255, filed on Apr. 26, 2024.
(60) Provisional application No. 63/624,657, filed on Jan. 24, 2024.
(60) Provisional application No. 63/582,964, filed on Sep. 15, 2023.

(51) Int. Cl. B25F 5/02; B25B 21/00

(52) U.S. Cl. CPC B25F 5/02; B25B 21/004

(57) ABSTRACT

A power tool includes a housing enclosing a motor and a sensor. The sensor is configured to control operation of the motor. The power tool includes an output device driven by the motor, a mount coupled to the sensor, and an actuator removably coupled to the mount. The actuator is slidable along the mount to couple the actuator to the mount.

### CROSS-REFERENCE TO RELATED APPLICATION

This application claims priority to co-pending U.S. Provisional Patent Application No. 63/639,255, filed Apr. 26, 2024, co-pending U.S. Provisional Patent Application No. 63/624,657, filed Jan. 24, 2024, and co-pending U.S. Provisional Patent Application No. 63/582,964, filed Sep. 15, 2023, the entire contents of each of which are incorporated by reference herein.

### FIELD

The present disclosure relates to power tools, and more particularly to actuator configurations for power tools.

### BACKGROUND

Power tools typically include actuatable buttons, triggers, etc. for a user to control the power tool.

### SUMMARY

Different users may have different preferences regarding a preferred type of actuator for controlling the power tool. Accordingly, a need exists for a power tool able to accommodate different user preferences by providing multiple actuator configurations and/or interchangeable actuators.

The present disclosure provides, in one aspect, a power tool including a housing enclosing a motor and a sensor. The sensor is configured to control operation of the motor. The power tool includes an output device driven by the motor, a mount coupled to the sensor, and an actuator removably coupled to the mount. The actuator is slidable along the mount to couple the actuator to the mount.

The present disclosure provides, in another aspect, a power tool including a housing enclosing a motor and a sensor defining a sensor axis. The sensor is configured to control operation of the motor. The power tool includes an output device driven by the motor, a mount coupled to the sensor and configured for axial displacement along the sensor axis, an actuator removably coupled to the mount and configured for axial displacement along the sensor axis, and a lockout member defining a lockout axis. The lockout member is configured to move between a first position and a second position along the lockout axis. The lockout member is proximal to the sensor axis in the second position relative to the first position.

The present disclosure provides, in another aspect, a power tool including a housing, a motor supported within the housing, an output device driven by the motor, and an input device supported within the housing. The input device includes a sensor configured to detect an input including a force or a displacement along a sensor axis, a controller configured to control operation of the motor based on feedback from the sensor, a mount coupled to the sensor, and a plurality of actuators interchangeably couplable to the mount. Each of the plurality of actuators having a different shape. A selected actuator of the plurality of actuators is manipulable to provide the input to the input device when the selected actuator is coupled to the housing.

Other features and aspects of the disclosure will become apparent by consideration of the following detailed description and accompanying drawings.

### BRIEF DESCRIPTION OF THE DRAWINGS

FIG. 1 illustrates a perspective view of a power tool embodying aspects of the present disclosure.

FIG. 2 is a cross-sectional view of the power tool of FIG. 1.

FIG. 3A is a schematic view of the power tool of FIG. 1, illustrating a first actuator coupled to an input device of the power tool.

FIG. 3B is an enlarged view of the first actuator.

FIG. 4A is a schematic view of the power tool of FIG. 1, illustrating a second actuator coupled to the input device.

FIG. 4B is an enlarged view of the second actuator.

FIG. 5 is a schematic view of the power tool of FIG. 1, illustrating a third actuator coupled to the input device.

FIG. 6 is a schematic view of the power tool of FIG. 1, illustrating a fourth actuator coupled to the input device.

FIG. 7 is a side view of a power tool according to another embodiment and illustrated with a first actuator configuration.

FIG. 8 is a side view of the power tool of FIG. 7, illustrated with a second actuator configuration.

FIG. 9A is a perspective view of a portion of a power tool according to another embodiment, illustrated with a first actuator configuration.

FIG. 9B is a side of the power tool of FIG. 9A, illustrating the first actuator configuration.

FIG. 10A is a perspective view of the power tool of FIG. 9A, illustrating a second actuator configuration.

FIG. 10B is a side view of the power tool of FIG. 9A, illustrating the second actuator configuration.

FIG. 11A is a perspective view of a portion of a power tool according to another embodiment.

FIG. 11B is a side of the power tool of FIG. 11A.

FIG. 12A is a side view of a portion of a power tool in an unlocked position, according to another embodiment.

FIG. 12B is a side view of the power tool of FIG. 12A with a housing removed.

FIG. 13A is a side view of the power tool of FIG. 12A in a locked position.

FIG. 13B is a side view of the power tool of FIG. 13A with the housing removed.

FIG. 14 is a schematic view of an actuator for use with the power tool of FIG. 1.

FIG. 15 is a schematic view of a PCB of the actuator of FIG. 14.

FIG. 16 illustrates a partial exploded view of an engagement portion of a power tool according to another embodiment.

FIG. 17 illustrates a side view of the power tool of FIG. 16 in an unlocked position.

FIG. 18 illustrates the side view of the power tool of FIG. 17 with the engagement portion actuated in the unlocked position.

FIG. 19 illustrates a side view of the power tool of FIG. 16 in the locked position.

FIG. 20 illustrates the side view of the power tool of FIG. 19 with the engagement portion actuated in the locked position.

FIG. 21 illustrates a side view of a lockout member of a power tool according to another embodiment.

FIG. 22 illustrates a side view of the power tool of FIG. 21 with the lockout member in an unlocked position.

FIG. 23 illustrates a side view of the power tool of FIG. 21 with the lockout member in a locked position.

FIG. 24 illustrates a side view of the power tool of FIG. 21 with the lockout member in a trigger swap position.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

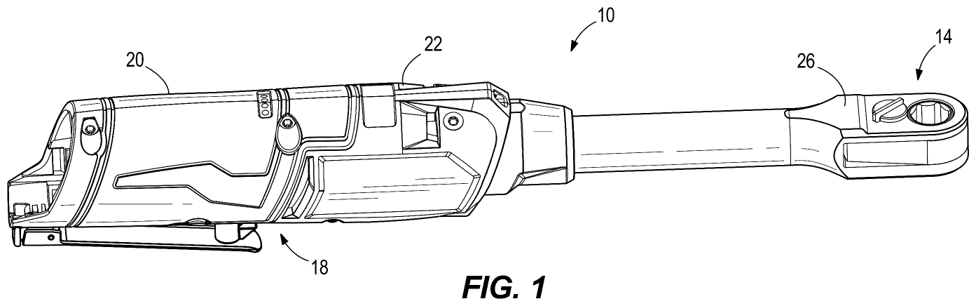

FIG. 1 illustrates a power tool 10, which in the illustrated embodiment is a powered box ratchet operable to rotate a fastener via an output device 14 (i.e., a ratchet assembly). The power tool 10 includes a housing 18 having a handle portion 20, a motor housing portion 22 extending from the handle portion 20, and a head 26 extending from the motor housing portion 22 and supporting the output device 14.

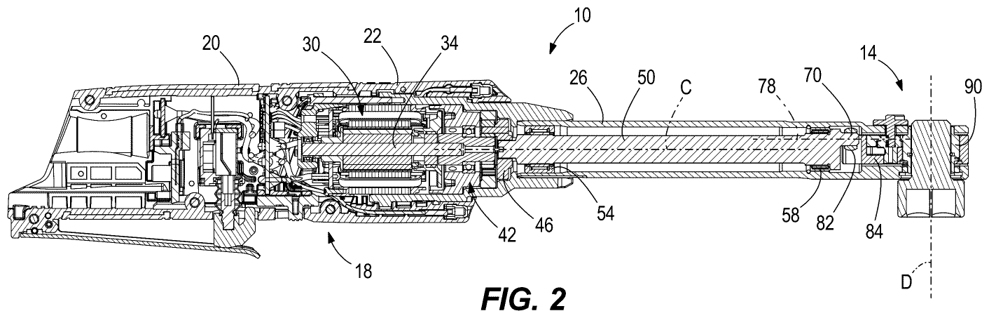

Referring to FIG. 2, the power tool 10 includes a motor 30 having an output shaft 34 is supported in the motor housing portion 22. The motor housing portion 22 encloses the motor 30. As described in greater detail below, the output device 14 is able to be driven by the motor 30. In the illustrated embodiment, the output shaft 34 is coupled to a gear assembly 42, which provides a speed reduction and torque increase from the output shaft 34 to a gear assembly output 46 (e.g., a planetary carrier of a single or multi-stage planetary transmission). In other embodiments, other types of gear assemblies may be used, or the gear assembly 42 may be omitted.

A crankshaft 50 is at least partially supported in the head 26 by first and second bearings 54, 58 (e.g., roller bearings). The crankshaft 50 is coupled to the output 46 of the gear assembly 42 at a first end and is rotatable about a crankshaft axis C along with the gear assembly output 46. A coupling portion 70 extends from a second end of the crankshaft 50. The coupling portion 70 defines a coupling axis 78 that is radially offset from the crankshaft axis C such that the coupling portion 70 is eccentrically oriented relative to the crankshaft 50. A bearing 82 (e.g., a spherical bearing) is coupled to the coupling portion 70 of the crankshaft 50. The bearing 82 engages a yoke 84 of the output device 14, such that rotation of the crankshaft 50 reciprocates the yoke 84 back and forth about a drive axis D perpendicular to the crankshaft axis C and the coupling axis 78. The yoke 84 supports one or more pawls (not shown) selectively engageable with teeth of a ratchet wheel 90 to drivably couple the yoke 84 to the ratchet wheel 90 in a selected rotational direction, and to permit the yoke 84 to rotate relative to the ratchet wheel 90 in a rotational direction opposite the selected rotational direction.

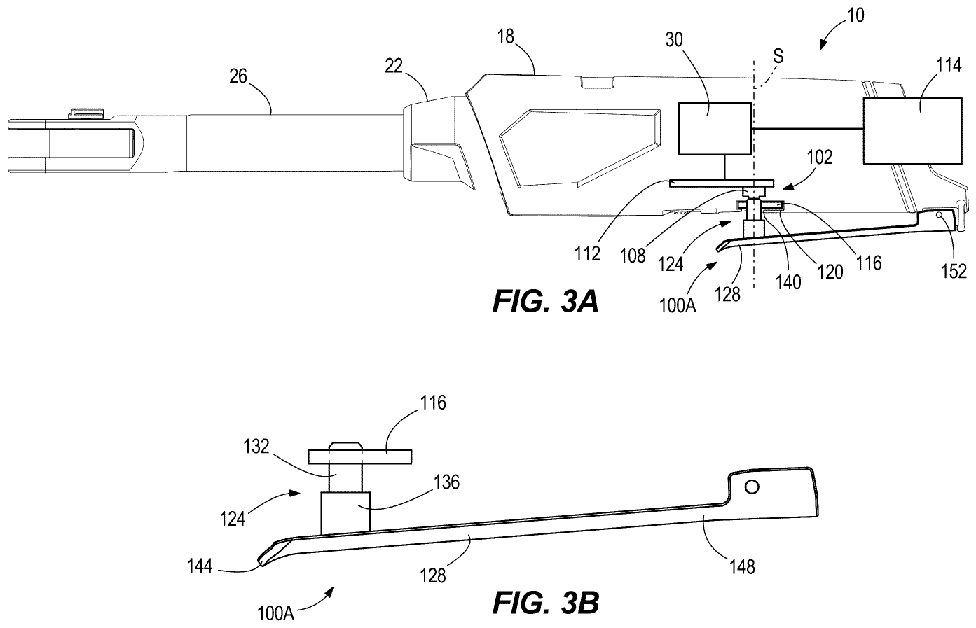

As described in greater detail below with reference to FIGS. 3A-11B and 14-15, the power tool 10 is compatible with multiple different actuators 100A, 100B, 100C, 100D, 100E, 100F, 100G, 100H, 100J, 100K, 100L, and 100M for controlling operation of the power tool 10 (e.g., energizing or de-energizing the motor 30, controlling an operating speed of the motor 30, etc.). The actuators 100A, 100B, 100C, 100D, 100E, 100F, 100G, 100H, 100J, 100K, and 100L and 100M may each have a different shape and are configured to be interchangeable to provide a user of the power tool 10 with the ability to select a preferred actuator configuration.

For example, FIGS. 3A and 3B illustrate an actuator 100A according to a first embodiment. The actuator 100A is configured to provide an input to an input device 102 of the power tool 10. The illustrated input device 102 includes a sensor 108 coupled to a printed circuit board (“PCB”) 112. The input device 102, and therefore the sensor 108, are enclosed by the housing 18. The PCB 112 may support one or more additional electrical or electronic components providing operational control for the power tool 10, such as a microprocessor, non-transitory, machine-readable memory, and switching transistors (e.g., MOSFETs, IGBTs, etc.) that selectively supply power from a power source (e.g., a battery pack 114) to the motor 30. Additionally or alternatively, the PCB 112 may be electrically connected to other controllers/PCBs within the power tool 10. All such components that provide operational control for the power tool 10 may be collectively referred to as a controller.

The sensor 108 is configured to output a signal (i.e., feedback) to the PCB 112 in response to displacement of the actuator 100A along a sensor axis or switch axis S. The sensor 108 may include a microswitch, a potentiometer switch, a force sensor, or any other type of sensor suitable for detecting movement and/or force on the actuator 100A and sending a signal to the PCB 112. The sensor 108 is configured to detect a force from a user along the sensor axis S.

With continued reference to FIGS. 3A-3B, the illustrated power tool 10 includes a first mount or a plate 116 adjacent and engageable with the sensor 108. The plate 116 is supported within a groove 120 in the housing 18. The first actuator 100A includes a projection 124 extending from a paddle actuator 128. The projection 124 includes a first portion 132 and a second portion 136 coupled together in a telescoping manner. A spring (not shown) may be disposed within the projection 124 between the first portion 132 and the second portion 136 to bias the first portion 132 in a direction away from the second portion 136. The first portion 132 is removably coupled to the plate 116 (e.g., magnetically, in some embodiments), and the second portion 136 is coupled to the paddle actuator 128. As illustrated in FIGS. 3A and 3B, the paddle actuator 128 includes a first end 144 and second end 148 coupled to the housing 18 at a second mount or hinge 152. The paddle actuator 128 will pivot about the hinge 152 upon force from the user along the sensor axis S to actuate the sensor 108 and operate the power tool 10.

In use, to activate the motor 30, a user applies force to the paddle actuator 128 such that the biasing force within the projection 124 is overcome and the first end 144 of the paddle actuator 128 moves toward the housing 18 of the power tool 10. The paddle actuator 128 pivots about the hinge 152, and the force applied by the user is transferred to the plate 116. In some constructions, the plate 116 is made of a flexible material, such as rubber. Due to the force on the plate 116, the plate 116 flexes inward and applies a force to the sensor 108, which in turn provides a signal to the PCB 112 and the controller of the power tool 10. In other embodiments, the plate 116 may be rigid but movably supported by the housing 18.

In some embodiments, the signal sent by the sensor 108 to the PCB 112 is proportional to the force applied to the sensor 108. In other embodiments, the sensor 108 may provide an on or off signal. In some embodiments, the controller of the power tool 10 may be configured to activate the motor 30 if a sensed force applied to the sensor 108 exceeds a predetermined minimum force. The predetermined minimum force is preferably enough to prevent unintended activation of the motor 30 (e.g., due to setting the tool 10 on a worksurface and the resulting force applied to the sensor 108 via the worksurface).

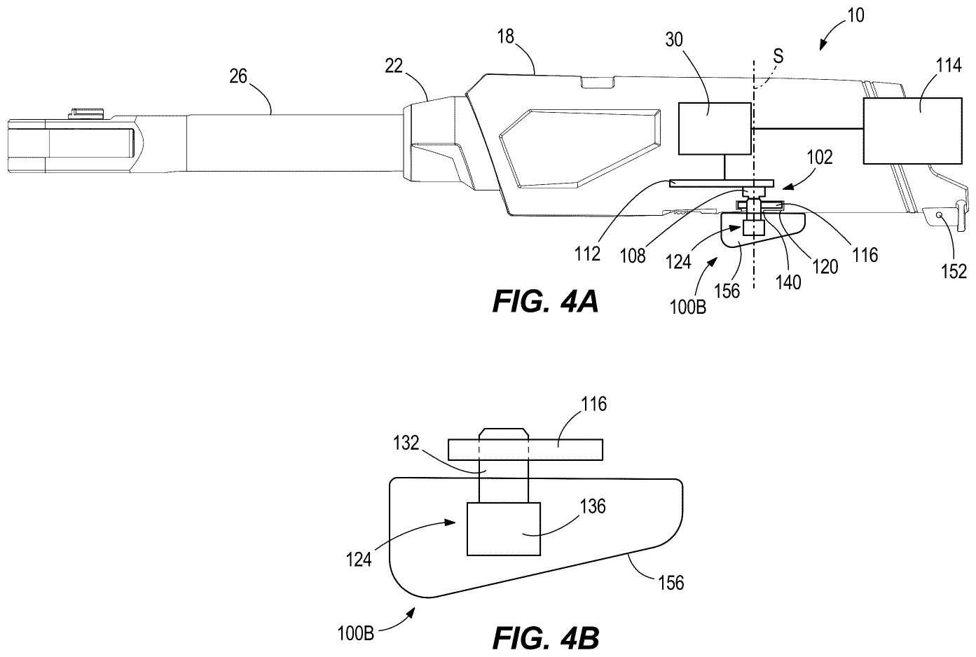

FIGS. 4A and 4B illustrate an actuator 100B according to another embodiment. Like the actuator 100A, the actuator 100B is configured to provide an input to the input device 102 of the power tool 10. The actuator 100A is removably coupled to the housing 18 of the power tool 10, such that the actuator 100A can be removed by a user and replaced with the actuator 100B, and vice versa.

The illustrated actuator 100B includes a trigger 156 and a projection 124 with a first portion 132 removably coupled to the plate 116, in a manner similar to the projection 124 of the actuator 100A described above. The trigger 156 provides a contoured actuating surface that may be engaged by the user to manipulate the actuator 100B.

In use, to activate the motor 30, a user applies force to the trigger 156 such that the biasing force within the projection 124 is overcome and the trigger 156 moves toward the housing 18 of the power tool 10. The trigger 156 may translate along the switch axis S, and the force applied by the user is transferred to the plate 116, which in turn engages the sensor 108 to provide a signal to the PCB 112 and the controller of the power tool 10.

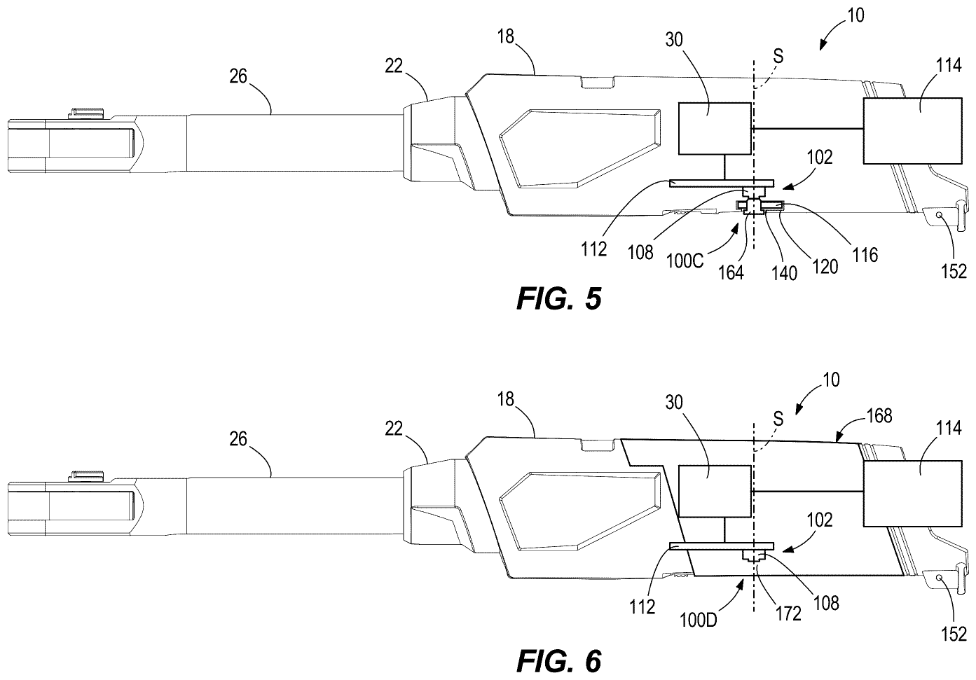

FIG. 5 illustrates an actuator 100C according to another embodiment. Like the actuators 100A, 100B, the actuator 100C is configured to provide an input to the input device 102 of the power tool 10. The actuator 100C is removably coupled to the power tool 10, such that the actuators 100A, 100B can be removed by a user and replaced with the actuator 100C, and vice versa.

The illustrated actuator 100C includes a pad or button 164 directly coupled to the plate 116 and positioned within an aperture 140 of the housing 18. In some embodiments, the button 164 may be generally flush with the outer surface of the housing 18.

In use, to activate the motor 30, a user applies force to the button 164, which is transferred to the plate 116, which in turn engages the sensor 108 to provide a signal to the PCB 112 and the controller of the power tool 10.

FIG. 6 illustrates an actuator 100D according to another embodiment. Like the actuators 100A, 100B, and 100C, the actuator 100D is configured to provide an input to the input device 102 of the power tool 10. The actuator 100D is removably coupled to the power tool 10, such that the actuators 100A, 100B, and 100C can be removed by a user and replaced with the actuator 100D, and vice versa.

In the illustrated embodiment, the actuator 100D includes a flexible overmold 168. In use, to activate the motor 30, a user applies force along the sensor axis S to a portion 172 of the overmold 168 overlying the sensor 108. This force is transmitted to the sensor 108 via the plate 116, or, in some embodiments, the plate 116 may be omitted and the overmold 168 may directly engage the sensor 108. In some embodiments, the sensor 108 may be an inductive sensor.

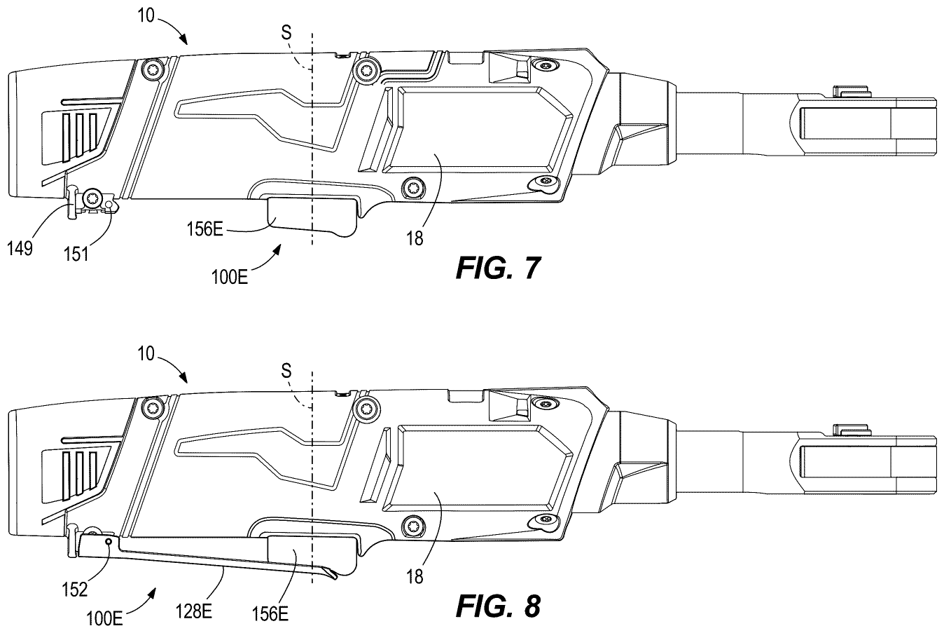

FIGS. 7 and 8 illustrate an actuator 100E according to another embodiment. Like the actuators 100A-100D, the actuator 100E is configured to provide an input to the input device 102 of the power tool 10. The actuator 100E is removably coupled to the power tool 10, such that the actuators 100A-100D can be removed by a user and replaced with the actuator 100E, and vice versa.

The illustrated actuator 100E includes two portions, which, in the illustrated embodiment, comprise a paddle 128E and a trigger 156E. The trigger 156E is coupled to the housing 18 and displaceable along the sensor axis S to control operation of the power tool 10. The illustrated housing 18 includes a projection 149 having a bore 151 (FIG. 7) that receives the hinge 152 (FIG. 8) to pivotally couple the paddle 128E to the housing 18. An opposite end of the paddle 128E is engageable with the trigger 156E when the paddle 128E is coupled to the housing 18. In some embodiments, the hinge 152 may be removable by a user of the power tool 10 to enable the user to selectively attach and remove the paddle 128E.

In use, the power tool 10 is configurable in a first actuator configuration, illustrated in FIG. 7, in which the paddle 128E is removed from the power tool 10. In the first actuator configuration, a user may control the power tool by directly engaging the trigger 156E. The power tool 10 is also configurable in a second actuator configuration, illustrated in FIG. 8, by coupling the paddle 128E to the hinge 152, such that the paddle 128E overlies and engages the trigger 156E. In the second actuator configuration, the paddle 128E is pivotable about the hinge 152 toward the housing 18, which in turn displaces the trigger 156E along the sensor axis S to control operation of the power tool 10.

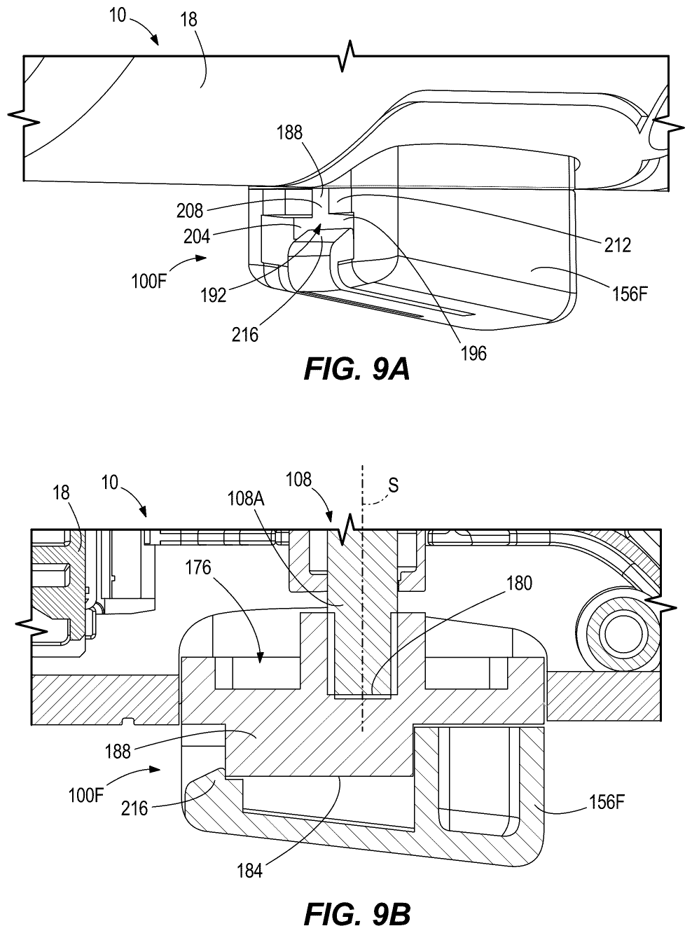

FIGS. 9A and 9B illustrate an actuator 100F according to another embodiment. Like the actuators 100A-100E, the actuator 100F is configured to provide an input to the input device 102 of the power tool 10 to control operation (i.e., energize and de-energize the motor, and optionally control an operating speed of the motor).

In the illustrated embodiment, the power tool 10 includes a mount 176 having a first side 180 and a second side 184 opposite the first side 180. The first side 180 is coupled to the sensor 108 to transfer force and/or motion to the sensor 108. For example, in the illustrated embodiment, the first side 180 of the mount 176 includes a recess that receives a post 108A extending from the sensor 108. The actuator 100F is removably coupled to the second side 184 of the mount 176 such that the actuator 100F may be interchangeable with other types of actuators, as described in greater detail below.

With continued reference to FIGS. 9A-9B, the second side 184 of the mount 176 includes a flange 188. The flange 188 forms generally a T-shaped structure that corresponds with a receiving element 192 on a trigger 156F. That is, the trigger 156F includes corresponding geometry (e.g., a receiving element 192) configured to receive the flange 188. The flange 188 includes a first side 196 and a second side 204 opposite the first side 196 with a mount connector 208 between the first side 196 and the second side 204. The receiving element 192 includes a pair of parallel guide rails 212 that engage the first side 196 and the second side 204 of the flange 188 when the trigger 156F is coupled to the mount 176. The trigger 156F includes a latch 216 to lock the trigger 156F to the flange 188. That is, the latch 216 retains the trigger 156F to the mount 176.

In use, the trigger 156F can be slid on to the mount 176 by the user, such that the pair of parallel guide rails 212 engages the first side 196 and the second side 204 of the flange 188 to lock the trigger 156F to the mount 176 in a first direction along the switch axis S. The latch 216 engages the flange 188 to lock the trigger 156F to the mount 176 in a second direction orthogonal to the first direction. The user may then depress the trigger 156F along the switch axis S, which causes the mount 176 to exert a force on (and, in some embodiments, displace) the sensor 108 to control operation of the power tool 10. To remove the trigger 156F from the mount 176, the user first depresses the latch 216 in the first direction such that the latch 216 no longer contacts the flange 188. The user then may slide the trigger 156F in the second direction to disengage the pair of parallel guide rails 212 from the first side 196 and the second side 204 of the flange 188.

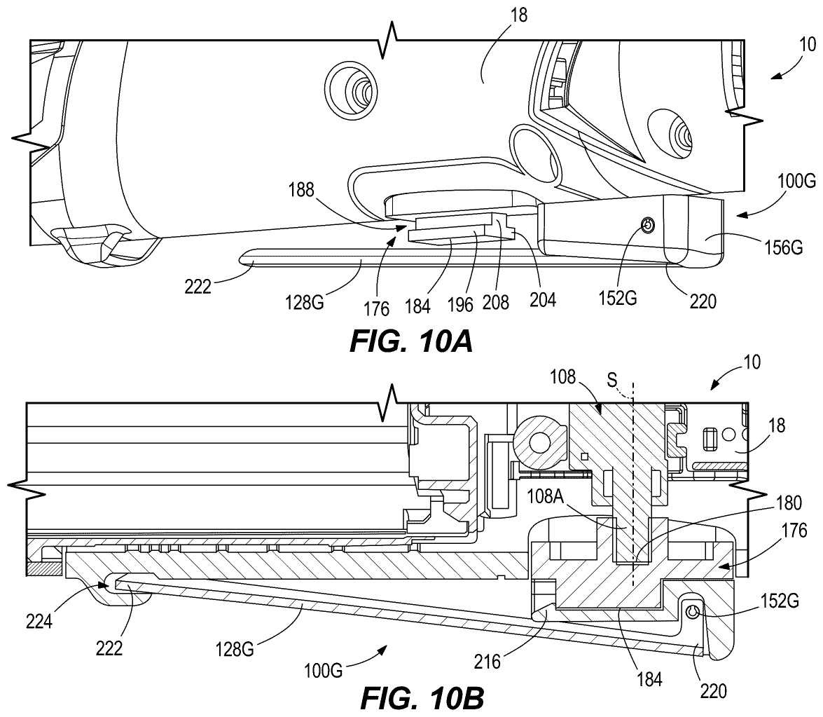

FIGS. 10A and 10B illustrate an actuator 100G according to another embodiment. The illustrated actuator 100G includes two portions, which, in the illustrated embodiment, comprise a paddle 128G and an attachment portion 156G (e.g., an actuator). The attachment portion 156G is removably coupled to the mount 176 in the same manner as the actuator 100F described above with reference to FIGS. 9A-9B, such that the two actuators 100F, 100G are interchangeable with one another. In the illustrated embodiment, the attachment portion 156G is slidable along the mount 176. In particular, the attachment portion 156G includes the pair of parallel guide rails 212 to engage with the first side 196 and the second side 204 of the flange 188 to lock the attachment portion 156G in the first direction. The attachment portion 156G further includes the latch 216 to engage with the flange 188 to lock the attachment portion 156G in the second direction.

The paddle 128G has a first end 220 and a second end 222. The first end 220 is pivotally coupled to the attachment portion 156G at a hinge 152G. The hinge 152G is positioned on the attachment portion 156G, such that when the attachment portion 156G is coupled to the mount 176, the user may depress the paddle 128G to displace the attachment portion 156G along the sensor axis S and thereby displace the sensor 108. The second end 222 of the paddle 128G is removably received in the housing 18 at a receptacle 224. The second end 222 may generally pivot or float inside of the receptacle 224 in response to pivoting of the first end 220 about the hinge 152G.

In use, when the attachment portion 156G is slid on the mount 176 by the user, the first side 196 and the second side 204 of the flange 188 engage the pair of parallel guide rails 212 of the attachment portion 156G to lock the attachment portion 156G to the mount 176 in the first direction along the switch axis S. The latch 216 engages a portion of the flange 188 to lock the attachment portion 156G to the mount 176 in the second direction orthogonal to the first direction. The second end 222 of the paddle 128G is received in the receptacle 224 of the tool housing 18. The user may then depress the paddle 128G to displace the attachment portion 156G along the switch axis S to control operation of the power tool. To remove the attachment portion 156G from the mount 176, the user first depresses the latch 216 in the first direction such that it no longer contacts the flange 188. The user then may remove the paddle 128G from the receptacle 224 and slide the attachment portion 156G in the second direction to disengage the pair of parallel guide rails 212 from the first side 196 and the second side 204 of the flange 188.

In other embodiments (not shown), the mount 176, including the flange 188, may be provided as part of the housing 18 of the power tool 10. In such embodiments, the actuator 100G may be removably coupled to the housing 18 in generally the same manner as described above, and the second end 222 of the paddle 128G may be engageable with the sensor 108.

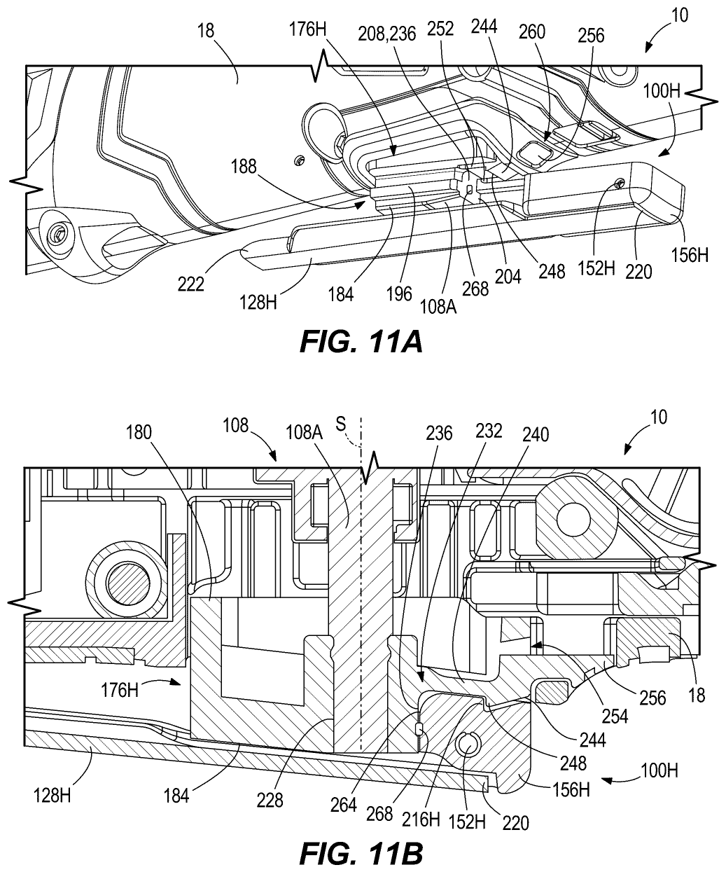

FIGS. 11A and 11B illustrate an actuator 100H according to another embodiment. The illustrated actuator 100H includes two portions, which, in the illustrated embodiment, comprise a paddle 128H and an attachment portion 156H. The paddle 128H includes a similar structure to the paddle 128G. The first end 220 is pivotally coupled to the attachment portion 156H at a hinge 152H to permit displacement of the attachment portion 156H along the sensor axis S.

The mount 176H is like the mount 176 and therefore only differences will be discussed. The mount 176H includes an aperture 228 that extends from the first side 180 to the second side 184 and is configured to receive the post 108A. The mount 176H includes a receptacle 232 defined by a first wall 236 and a second wall 240 that is configured to mate with the attachment portion 156H, which will be described in detail below. The second wall 240 includes an angled surface 244 and a ledge 248 that is configured to engage a latch 216H. The second wall 240 is flanked by a pair of slots 252 on each side that serve to isolate the second wall 240 from other portions of the mount 176H. Additionally, a gap 254 is formed between the second wall 240 and another portion of the mount 176H. The pair of slots 252 and the gap 254 enable displacement of the second wall 240 relative to the rest of the mount 176H. In other words, the second wall 240 is resiliently coupled to the mount 176H. The second wall 240 includes an engagement portion 256 that is disposed radially outwards from the ledge 248 relative to the axis S. Specifically, the engagement portion 256 is received within an opening 260 of the housing 18. In the illustrated embodiment, the second wall 240 and the engagement portion 256 are combined in a monolithic structure.

In use, when the attachment portion 156H is slid on the mount 176H by the user, the first side 196 and the second side 204 of the flange 188 engage the pair of parallel guide rails 212 of the attachment portion 156H to lock the attachment portion 156H to the mount 176H in the first direction along the switch axis S. As the attachment portion 156H is being slid on the flange 188, a surface 264 of the attachment portion 156H engages the angled surface 244 of the mount 176H and displaces the second wall 240 in the first direction along the switch axis S. Specifically, the force of the surface 264 on the second wall 240 deflects the second wall along the switch axis S and toward the crankshaft axis C (FIG. 2). Upon full insertion of the attachment portion 156H on the mount 176H, the latch 216H engages the ledge 248 of the mount 176H to lock the attachment portion 156H to the mount 176H in the second direction orthogonal to the first direction.

To remove the attachment portion 156H from the mount 176H, the user first depresses the engagement portion 256 in the first direction such that the second wall 240 is displaced toward the crankshaft axis C (FIG. 2). In some embodiments, the gap 254 limits the displacement of the second wall 240 relative to the rest of the mount 176H. In other embodiments, the housing 18 limits the displacement of the second wall 240 relative to the mount 176H. Limiting the displacement of the mount 176H prevents potential damage of the second wall 240 (e.g., the second wall 240 breaking off the mount 176H). Upon displacing the second wall 240 via the engagement portion 256, the attachment portion 156H is no longer locked in the second direction because the latch 216H is no longer engaged with the ledge 248. As such, the user then may slide the attachment portion 156H in the second direction to disengage the pair of parallel guide rails 212 from the first side 196 and the second side 204 of the flange 188. In some embodiments, the mount 176H includes a biasing member 268 configured to assist in the removal of the attachment portion 156H. Specifically, the first wall 236 includes the biasing member 268 such that the biasing member 268 engages the attachment portion. In other embodiments, the biasing member 268 is mounted on the attachment portion 156H and is configured to engage the first wall 236.

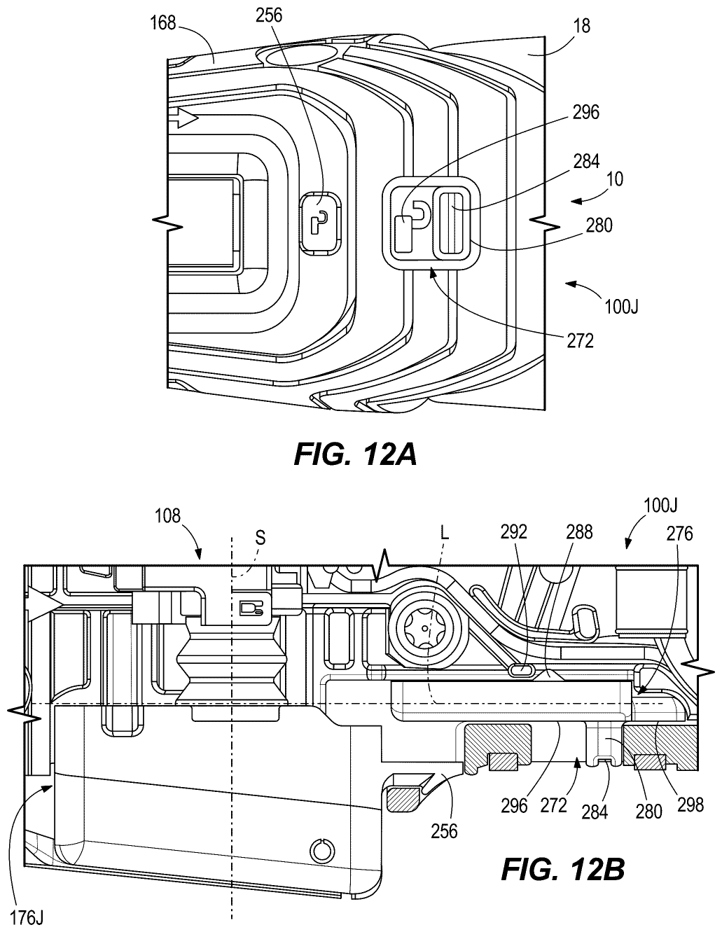

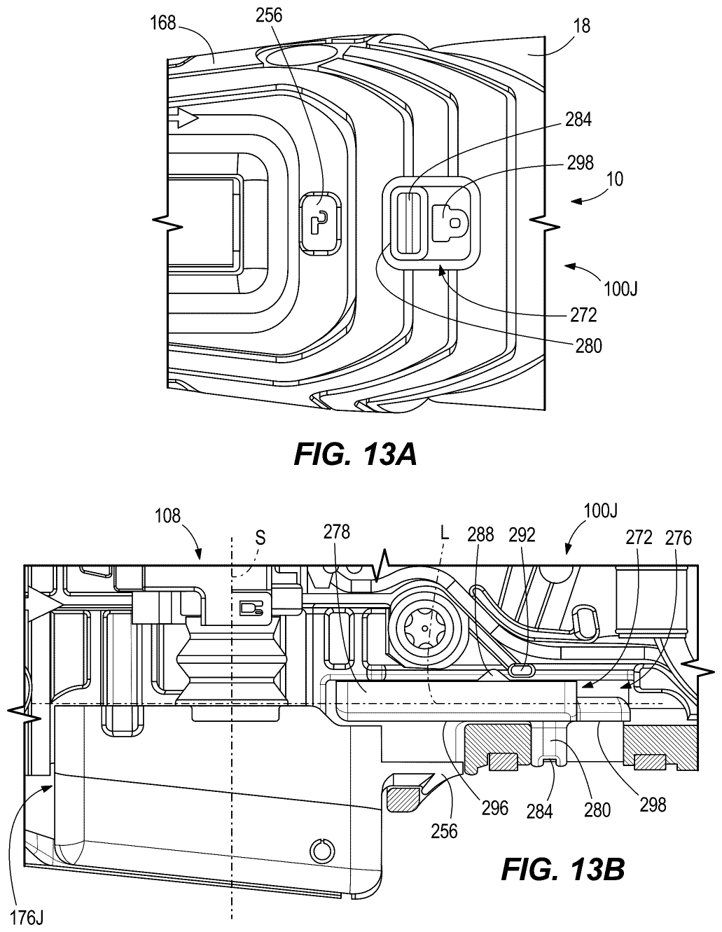

FIGS. 12A-13B illustrate an actuator 100J according to another embodiment. The actuator 100J is like the actuator 100H and therefore only differences will be discussed. The actuator 100J is compatible with a lockout member 272. The lockout member 272 is disposed in a receptacle 276 of the housing 18 and is configured to slide along a lockout axis L. The lockout axis L is perpendicular to the switch axis S. The lockout member 272 includes a body 278 having a projection 280 configured to be engaged by a user such that the lockout member 272 may be slide along the lockout axis L. The projection 280 includes a groove 284 configured to be engaged by a user. The lockout member 272 includes a projection 288 that is configured to engage a portion 292 of the housing 18. The contact between projection 288 and the portion 292 effectively holds the lockout member 272 in an unlocked position or a locked position.

FIGS. 12A and 12B illustrate the lockout member 272 in the unlocked position. In the unlocked position, the lockout member 272 does not overlap with the mount 176J thereby permitting the actuator 100J to be axially displaced along the switch axis S. In other words, the user is capable of actuating the sensor 108 via the actuator 100J in the unlocked position. In the unlocked position, the projection 288 is located on a first side of the portion 292. The lockout member 272 includes an indicator 296 that is configured to identify that the lockout member is in the unlocked position. In the illustrated embodiment, the indicator 296 is an embossed or debossed unlocked symbol. In other embodiments, the indicator 296 is paint applied to the lockout member 272 (e.g., a shade of green).

FIGS. 13A and 13B illustrate the lockout member 272 in the locked position. In the locked position, the lockout member 272 overlaps with the mount 176J thereby preventing the actuator 100J from being axially displaced along the switch axis S. In other words, the user cannot actuate the sensor 108 via the actuator 100J in the locked position. In the locked position, the projection 288 is located on a second side of the portion 292. The lockout member 272 includes an indicator 298 that is configured to identify that the lockout member is in the locked position. In the illustrated embodiment, the indicator 298 is an embossed or debossed locked symbol. In other embodiments, the indicator 298 is paint applied to the lockout member 272 (e.g., a shade of red). In the locked position, the indicator 298 is visible and the indicator 296 is hidden within the housing 18. In the unlocked position, indicator 296 is visible and the indicator 298 is hidden within the housing 18.

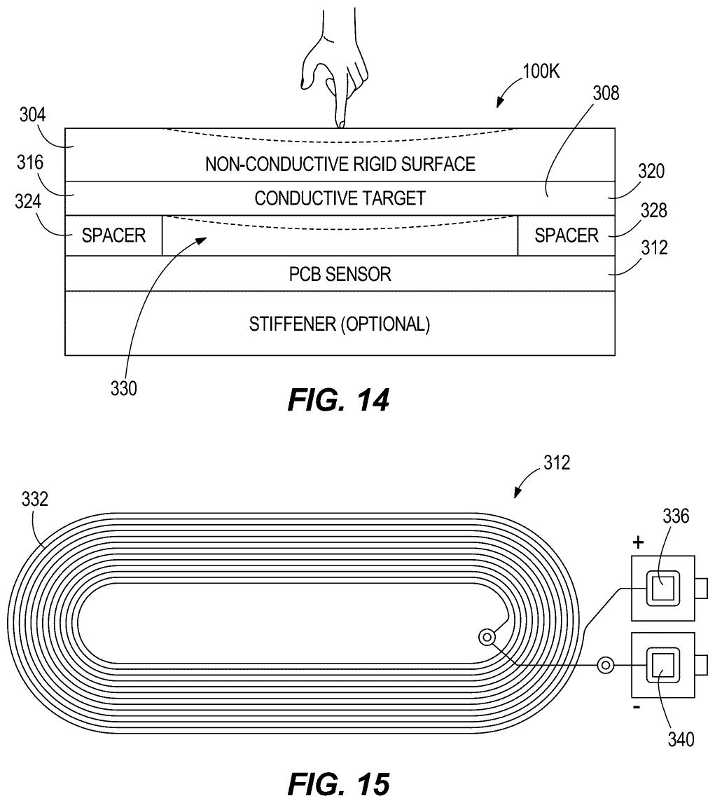

FIG. 14 illustrates an actuator 100K according to another embodiment. Like the actuators 100A-100D, the actuator 100K is configured to provide an input to the input device 102 of the power tool 10. In some embodiments, the actuator 100K is removably coupled to the power tool 10, such that the actuator 100K can be removed by a user and replaced with another actuator (e.g., the actuators 100A-100D), and vice versa. The actuator 100K is an inductive sensor and includes a non-conductive surface 304, a conductive surface 308, and a PCB sensor 312. The non-conductive surface 304 may be comprised of any flexible and non-conductive material (e.g., rubber). The non-conductive surface 304 engages the conductive surface 308, such that the conductive surface 308 is displaced when the non-conductive surface 304 is actuated by the user. The conductive surface 308 may be comprised of any flexible and conductive material (e.g., aluminum). The conductive surface 308 extends from a first end 316 to a second end 320 opposite the first end 316. The actuator 100K includes a first spacer 324 disposed adjacent to the first end 316 and a second spacer 328 disposed adjacent to the second end 320. The first spacer 324 and the second spacer 328 define a gap 330 therebetween.

With reference to FIG. 15, the PCB sensor 312 includes a track 332 electrically connected to a positive terminal 336 and a negative terminal 340 such that electrical current passes through the track 332. The track 332 is a singular wire forming concentric ovals. The track 332 is positioned below the conductive surface 308 and between the spacers 324, 328.

To activate the motor 30, the user applies a force to the non-conductive surface 304 in a direction toward the PCB sensor 312. As a result, the non-conductive surface 304 and the conductive surface 308 is displaced (e.g., flexed) toward the track 332 on the PCB sensor 312. The conductive surface 308 is displaced (e.g., flexed) into the gap 330 between the spacers 324, 328, thereby disrupting the electromagnetic field of the current passing through the track 332. The PCB sensor 312 detects the disruption of the electromagnetic field via the track 332 and controls operation of the power tool 10.

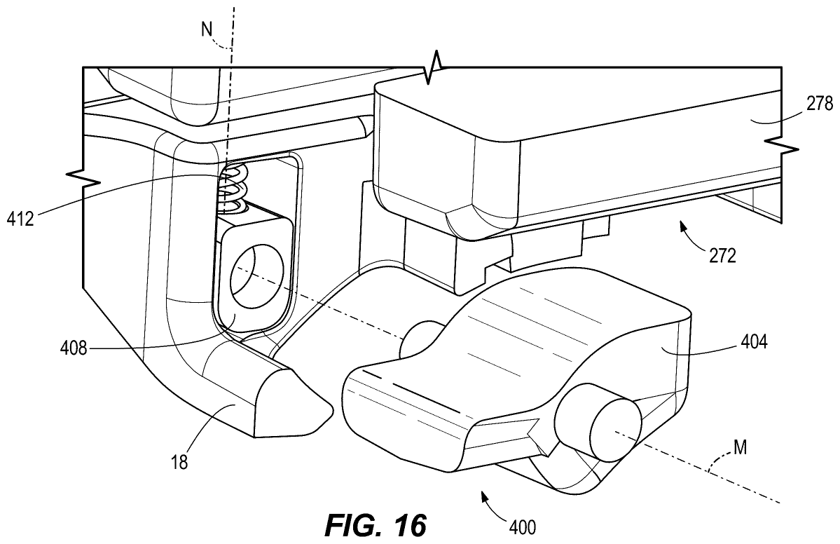

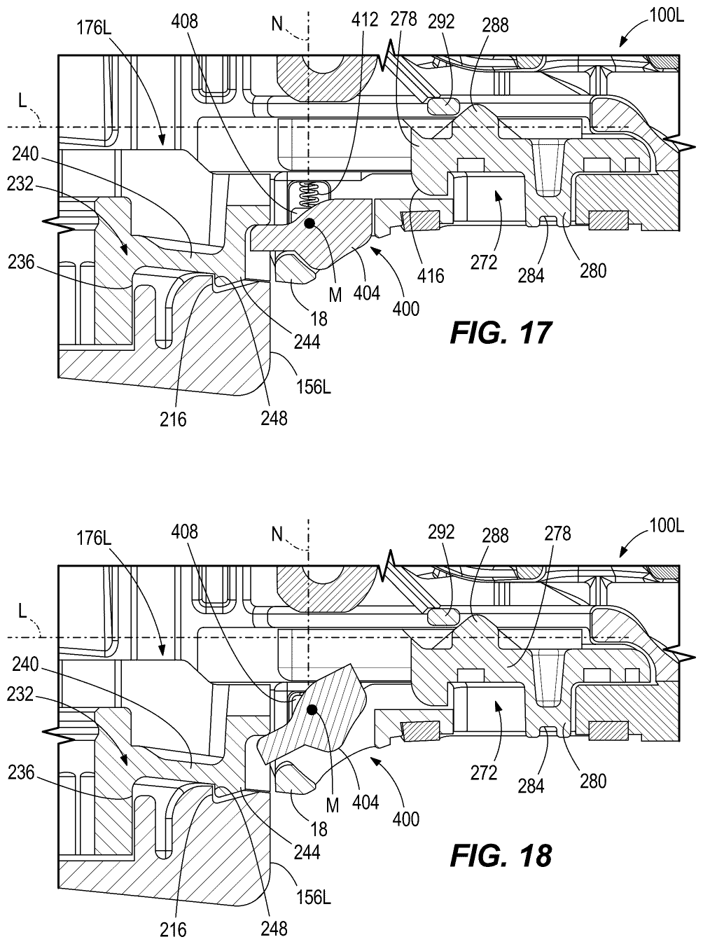

FIGS. 16-20 illustrate an engagement portion 400 according to another embodiment. The engagement portion 400 is like the engagement portion 256 and therefore only differences will be discussed. The engagement portion 400 is compatible with an actuator 100L according to another embodiment (FIG. 17). In the illustrated embodiment, the engagement portion 400 is separate from the second wall 240 (e.g., two separate parts). The engagement portion 400 includes a pivot member 404 received within a detent 408 that defines a pivot axis M. The engagement portion 400 includes a biasing member 412 that engages the detent 408. The biasing member 412 defines an axis N in which the detent 408 may be axially displaced. As shown in FIG. 16, the detent 408 is biased toward the housing 18 via the biasing member 412.

FIGS. 17 and 18 illustrate the lockout member 272 in an unlocked position. As shown in FIG. 18, upon a user depressing the pivot member 404, the detent 408 is displaced axially along the axis N against the force of the biasing member 412 and into the housing 18.

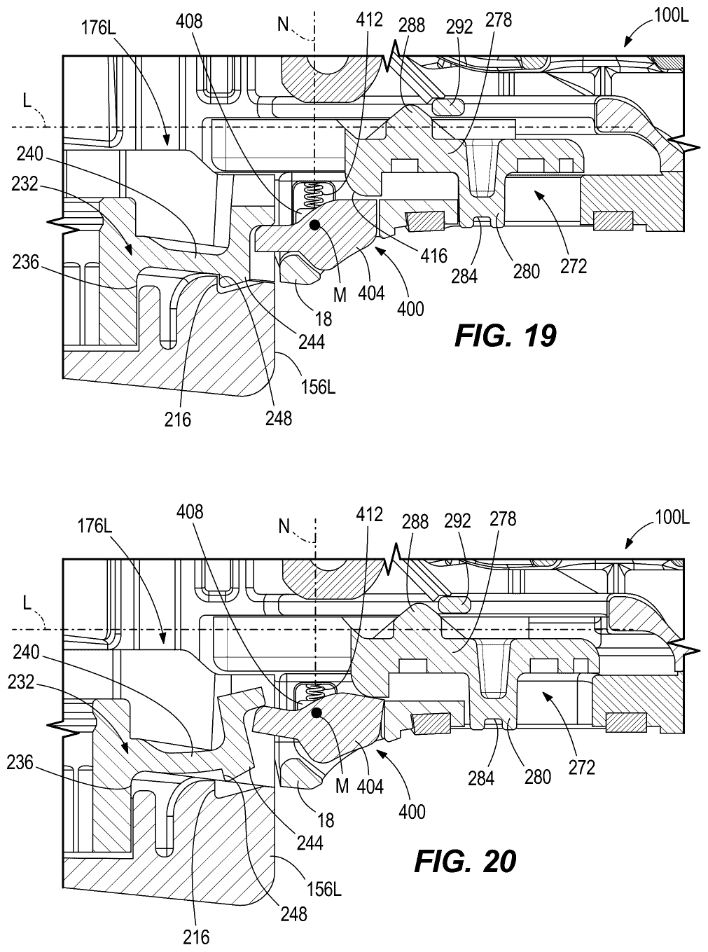

FIGS. 19 and 20 illustrate the lockout member 272 in a locked position (i.e., the lockout member 272 is displaced along the lockout axis L). In the locked position, the lockout member 272 includes a surface 416 that abuts the pivot member 404. Upon a user depressing the pivot member 404, the surface 416 prevents the pivot member 404 from being axially displaced along the axis N. Since the detent 408 is not displaced axially along the axis N, the pivot member 404 pivots about the axis M clockwise and into engagement with the mount 176L. The second wall 240 of the mount 176L is resilient such that the ledge 248 disengages the latch 216 of the trigger 156L upon a sufficient force of the pivot member 404. The trigger 156L may be removed from the mount 176L upon disengagement of the ledge 248 with the latch 216.

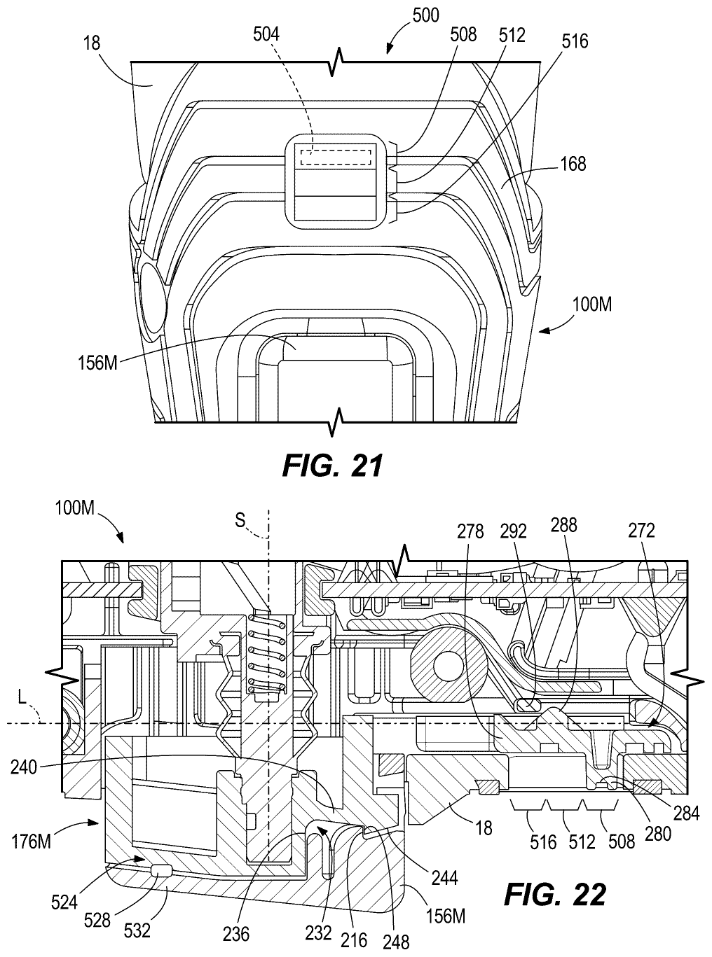

FIG. 21 illustrates another embodiment of a lockout member 500 compatible with an actuator 100M. The lockout member 500 includes a body 504 to be engaged by the user. In some embodiments, the body 504 has the projection 280 and the groove 284. In the illustrated embodiment, the lockout member 500 is adjustable between an unlocked position 508, a locked position 512, and a trigger swap position 516. FIG. 21 illustrates the lockout member 500 in the unlocked position.

FIG. 22 illustrates a cross section of the actuator 100M with the lockout member 500 in the unlocked position 508. The actuator 100M is similar to the actuator 100J and therefore only differences will be discussed. The actuator 100M includes the mount 176M having a projection 520 that extends from the second wall 240 and intersects the lockout axis L. That is, the projection 520 intersects and is perpendicular to the lockout axis L. As the trigger 156M is depressed, the projection 520 is axially displaced in a direction that is parallel to the switch axis S. In the illustrated embodiment, the second wall 240 and the projection 520 are combined in a monolithic structure. The projection 520 functions as an engagement portion. In contrast to the engagement portions 256, 400, the projection 520 is contained within the housing 18.

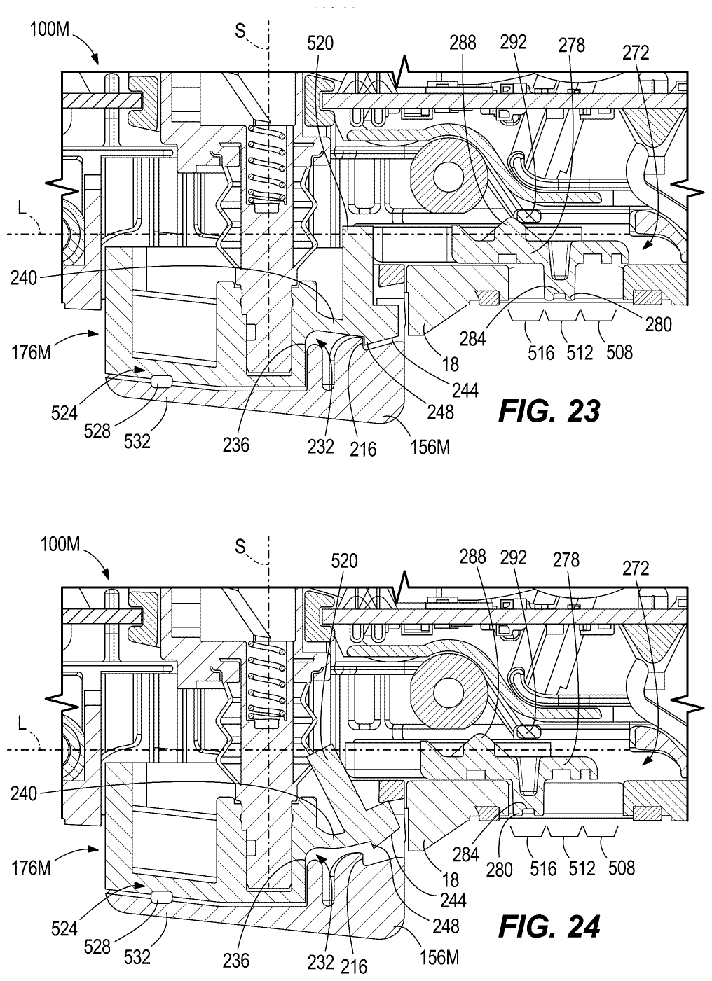

FIG. 23 illustrates a cross section of the actuator 100M with the lockout member 500 in the locked position 512. In the locked position 512, the lockout member 500 is disposed along the lockout axis L such that the projection 288 is disposed on a side of the portion 292 proximal to the switch axis S. Specifically, the lockout member 500 is axially located between the portion 292 and the projection 520. In the locked position, the trigger 156M cannot be displaced along the lockout axis L because the lockout member 500 overlaps with the mount 176M which prevents the actuator 100M from being axially displaced along the switch axis S. In other words, the user cannot actuate the sensor 108 via the actuator 100M in the locked position since the lockout member 500 fixes the mount 176M axially along the lockout axis L.

FIG. 24 illustrates a cross section of the actuator 100M with the lockout member 500 in the trigger swap position 516. In the trigger swap position 516, the lockout member 500 is slid along the lockout axis L and toward the switch axis S. The second wall 240 of the mount 176M is resilient (e.g., capable of deflection) upon the user sliding the lockout member 500 from the locked position 512 (FIG. 23) to the trigger swap position 516. The deflection of the second wall 240 is exaggerated in FIG. 24 to illustrate the projection 520 being pivoted relative to the switch axis S. Upon the projection 520 being displaced, the ledge 248 disengages from the latch 216 and thereby enables a user to remove the trigger 156M. In some embodiments, the actuator 100M includes a detent interface 524 defined between the trigger 156M and the mount 176M. The detent interface 524 is configured to prevent the trigger 156M from falling off in the trigger swap position 516. For instance, if a user accidently moves the lockout member 500 to the trigger swap position 516, the detent interface 524 prevents the trigger 156M from freely falling off. In other words, the detent interface 524 provides additional resistance between the trigger 156M and the mount 176M. In some embodiments, the detent interface 524 includes a projection 528 on the mount 176M and the trigger 156 incudes a recess 532 configured to receive the projection 528.

Thus, the present disclosure provides, among other things, a power tool 10 compatible with multiple different actuators 100A, 100B, 100C, 100D, 100E, 100F, 100G, 100H, 100J, 100K, 100L, and 100M for controlling operation of the power tool 10. The actuators 100A, 100B, 100C, 100D, 100E, 100F, 100G, 100H, 100J, 100K, 100L, and 100M may be interchangeable to provide a user of the power tool 10 with the ability to select a preferred actuator configuration. Although the power tool 10 is described and illustrated herein as a powered ratchet, the actuators 100A-100M, described and illustrated herein may be incorporated into other types of power tools, such as drills, impact drivers, sanders, grinders, and the like.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A power tool comprising:
a housing enclosing a motor and a sensor, wherein the sensor is configured to control operation of the motor;
an output device driven by the motor;
a mount coupled to the sensor; and
an actuator removably coupled to the mount,
wherein the actuator is slidable along the mount to couple the actuator to the mount.

2. The power tool of claim 1, wherein the actuator includes an attachment portion removably coupled to the mount and a paddle pivotally coupled to the attachment portion.

3. The power tool of claim 2, wherein the paddle includes a first end and a second end and wherein the housing includes a receptacle configured to receive the second end.

4. The power tool of claim 1, wherein the actuator includes a latch to retain the actuator on the mount.

5. The power tool of claim 1, wherein the mount includes a first wall and a second wall that define a receptacle configured to receive the actuator.

6. The power tool of claim 5, wherein the first wall includes a biasing member configured to engage the actuator.

7. The power tool of claim 5, wherein the actuator includes a biasing member configured to engage the first wall.

8. The power tool of claim 5, wherein the second wall includes a pair of slots.

9. The power tool of claim 8, wherein the second wall is resiliently coupled to the mount.

10. The power tool of claim 1, wherein the mount includes a flange and wherein the actuator includes a receiving element configure to receive the flange.

11. The power tool of claim 10, wherein the receiving element includes a pair of parallel guide rails.

12. A power tool comprising:
a housing enclosing a motor and a sensor defining a sensor axis, wherein the sensor is configured to control operation of the motor;
an output device driven by the motor;
a mount coupled to the sensor and configured for axial displacement along the sensor axis;
an actuator removably coupled to the mount and configured for axial displacement along the sensor axis; and
a lockout member defining a lockout axis, the lockout member being configured to move between a first position and a second position along the lockout axis,
wherein the lockout member is proximal to the sensor axis in the second position relative to the first position.

13. The power tool of claim 12, wherein the lockout axis is perpendicular to the sensor axis.

14. The power tool of claim 12, wherein in the second position, the lockout member engages the mount such that the mount is axially fixed along the sensor axis.

15. The power tool of claim 12, wherein the mount includes a first wall and a second wall that define a receptacle configured to receive the actuator.

16. The power tool of claim 15, wherein the second wall includes a projection extending in a direction parallel to the sensor axis and toward the sensor, and wherein the projection intersects the lockout axis.

17. The power tool of claim 15, further comprising an engagement portion, wherein the engagement portion and the second wall are combined in a monolithic construction.

18. The power tool of claim 15, further comprising an engagement portion, wherein the engagement portion includes a detent received by the housing and a pivot member pivotably receive by the detent, wherein the pivot member is configured to engage the second wall.

19. The power tool of claim 12, further comprising a detent interface defined between the actuator and the mount.

20. A power tool comprising:
a housing;
a motor supported within the housing;
an output device driven by the motor;
an input device supported within the housing, the input device including a sensor configured to detect an input including a force or a displacement along a sensor axis;
a controller configured to control operation of the motor based on feedback from the sensor;
a mount coupled to the sensor; and
a plurality of actuators interchangeably couplable to the mount, each of the plurality of actuators having a different shape,
wherein a selected actuator of the plurality of actuators is manipulable to provide the input to the input device when the selected actuator is coupled to the housing.
